(19) United States
(12) Patent Application Publication
(10) Pub. No.: US 2001/0037367 A1
(43) Pub. Date: Nov. 1, 2001

(54) System and method for sharing information via a virtual shared area in a communication network

(76) Inventor: Sridhar V. Iyer, Plano, TX (US)

Correspondence Address: David L. McCombs, Haynes and Boone, LLP, Suite 3100, 901 Main Street, Dallas, TX, 75202, US

(21) Appl. No.: 09/822,673

(22) Filed: Mar. 30, 2001

Related U.S. Application Data
(60) Provisional application No. 60/210,686, filed on Jun. 14, 2000.

(51) Int. Cl. G06F 15/16; G09G 5/00

(52) U.S. Cl. 709/204; 345/758

(57) ABSTRACT

A system and method is disclosed for information sharing via a virtual shared area in a communication network. The system includes a virtual shared area having a unique electronic identifier, the shared area being controlled by an owner for permitting access to information in the shared area by multiple users. The users are allowed to connect to the shared area and transfer at least a portion of the information to a user device. The owner initiates a control-sharing of the information and shares with all the users if the users maintain a communication link with the virtual shared area. Multiple users can control the shared area in a predetermined manner as well.

### CROSS REFERENCE

This application claims the benefit of provisional patent application Ser. No. 60/210,686 filed on Jun. 14, 2000.

### BACKGROUND

This application relates generally to the sharing of information through a communication network, and more particularly, to a system and method for sharing information via a virtual area by multiple parties in a communication network with various control features vested in one predetermined party.

In conventional systems and methods for sharing information, an originator of the information will typically provide the information through an electronic site such as a web site. Users wishing to obtain the information must have available to them, or must download, specific software to their computers or other devices that allow them to access and otherwise use, store, play, or display the information. Representative examples of information typically shared in this manner include, among other things, text, graphical images, sound files, and the like. Once information is obtained by a user, the originator has little (if any) ability to control what the user does with the information. For example, the user subsequently may, in violation of the wishes of the originator, copy the information or disseminate it such that the originator is no longer able to control by whom and when the shared information can be listened to, read, or seen.

Another problem associated with sharing the information is information overload. Too much available information makes it difficult for users to decide what they would like to obtain from the available universe of information.

Accordingly, methods of organizing information and sharing it among groups with similar interests is highly desirable.

Therefore, an improved system and method for sharing information in a communication network is desired to reduce or eliminate the aforementioned complexities and limitations.

### SUMMARY

In response to these and other limitations, provided herein is a unique system and method for sharing information via a virtual shared area in a communication network.

The system includes a virtual shared area having a unique electronic identifier, the shared area being controlled by an owner for permitting access to information in the shared area by a user device. The user device is allowed to connect to the shared area and pick up a piece of owner-selected information for transmission to the user device. The owner initiates a transmission or controlled-sharing of the selected information to the connected user device and the user device encodes the unique electronic identifier for the control-shared information and an owner identifier. The user device maintains the connection to the location of the information in the shared area and stores, in a permanent storage area of the user device, the transmitted information. If the user device attempts to access the stored transmitted information, a connection is made to the shared area with the assistance from the unique electronic identifier, which identifies the owner, and the access will be granted if the owner is currently control-sharing the stored information.

In one example, the owner of a virtual area will have the privilege to initiate and play selected audio information such as a music piece in his/her virtual area. All visitor clients that are in the “virtual proximity” (or that are electronically connected) to the virtual area and invited by the owner will be able to hear the music so long as they are connected to the virtual area. Music (or more specifically, a music file) originated by the owner can be transmitted to the visitors by physically streaming the information through the connection while the visitors stay connected. Alternatively, the music can be transmitted (or downloaded) before being played. While streaming the music to the visitor device, a temporary memory buffer is used to simultaneously play the music. The music file is deleted immediately when the connection to the virtual shared area is removed.

If the music file is downloaded to the visitor device, it can also be stored in a permanent memory device. If so, the music file may encode information about the virtual shared space from where the music was downloaded using the unique electronic identifier. In this way, the music file will be played only when the visitor has an electronic connection made to the virtual shared area from where the music was downloaded, and the owner of the virtual shared space is playing or control-sharing the same music file. If the visitor joins the virtual shared area while the music is being played by the owner, the music file on the visitor's side will start from a point in the music file where the control-sharing is at the moment. Hence, even if the entire music file is stored on a visitor device, the play back of the music file is controlled exclusively by the owner of the virtual shared area.

In another example of the present invention, a method is disclosed for sharing a virtual area among a plurality of users. A first user of the virtual area is admitted to take the control of the virtual area for sharing a first subject information. A second user is subsequently admitted to the virtual area, the second user having a desire to control the virtual area for sharing a second subject information. A negotiation ensues between the first and the second users for the control of the virtual area. Based on the negotiation, either the first or the second subject information is control-shared by the first or the second user in the virtual area respectively.

In yet another example of the present invention, a method is disclosed for sharing multi-media information in a virtual studio on the Internet. The virtual studio has a plurality of virtual rooms, and each room is for accommodating a group of users. First, an owner of a virtual room in the virtual studio is established. He invites a plurality of visitors to the virtual room, and broadcasts the multi-media information in the virtual room to be shared by the visitors simultaneously if a communication link is maintained between the visitors and the virtual room.

### BRIEF DESCRIPTION OF THE DRAWINGS

FIG. 1 is a diagrammatic view of a system of the present invention.

FIG. 2 is a diagrammatic view of a virtual shared space of the present invention.

FIG. 3 is a diagrammatic view of an elaborate virtual shared space of the present invention.

FIG. 4a is a diagrammatic view of a visitor client display.

FIG. 4b is a flow chart of a method of the present invention for sharing information in a communication network.

FIG. 5 is a computer system for implementing the present invention.

FIG. 6 is a schematic for illustrating how a visitor invites a plurality of visitors to join him to view a movie in the shared area according to one example of the present invention.

FIG. 7 illustrates a flow diagram representing steps taken for sharing the control of the shared area according to one example of the present invention.

### DETAILED DESCRIPTION

In a broader sense, for virtual shared space or areas created by any communication network infrastructure, certain virtual shared areas are designed to be controlled by an owner whose absolute power to manage his possession is not compromised even if he temporarily shares some of the control with his visitors. On the other hand, the visitors can have certain access to the same virtual shared area so that they can get the benefit of using such a virtual shared area. Control mechanisms are implemented by various embodiments of the present invention so that the virtual space can be used for the benefit of both the owner and the visitors to share information.

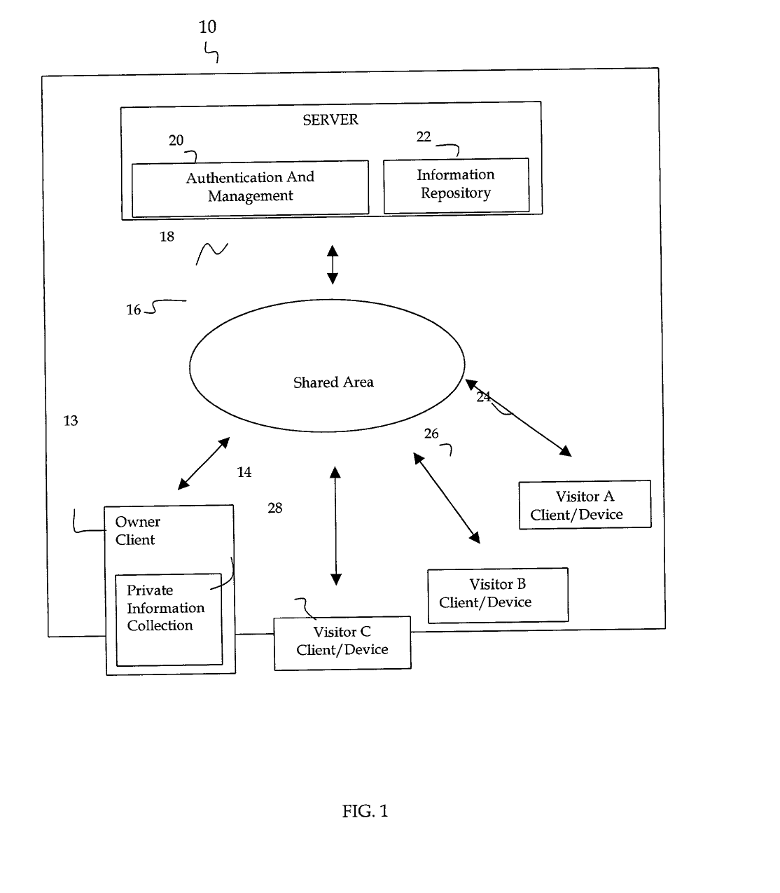

FIG. 1 depicts a communication network 10 for implementing one embodiment of the present invention. The network 10 includes an owner client 12 that stores a private collection of subject information 14. The owner client 12 may be an electronic device such as a personal computer, network appliance, setup box, or the like, to be controlled by an owner. A virtual shared area (SA) 16 is an electronic area where multiple users or visitors can gather together and interact. The SA 16 may be created and maintained by a hosting party other than the owner or the visitors. It is also possible that the owner client 12 is the hosting party itself, and provides the subject information 14 to the SA. The SA 16 will have a unique identifier (such as a Universal Resource Locator (URL) for the World Wide Web) and will contain information about the current state below of the SA, discussed below. A key feature of the SA 16 is that it connects multiple users through electronic means (e.g., through visitor clients 24-28) and one person or entity (e.g., the owner) is in charge of the gathering. The visitor clients 24-28, which may be a variety of electronic devices, can connect to the SA 16 in order to access the subject information 14 and communicate with one another. The owner is in charge of the SA 16 and has the control to limit the visitor clients' privileges and accesses through password protection and/or other similar mechanisms. Owners and visitors may optionally be represented as 3D avatars or characters, and the SA 16 may comprise a metaphor such as that of a show room.

In order to access the subject information 14 via the SA 16, the owner must first initiate a transmission of the subject information by streaming the information to the users or sending the information in its entirety before being accessed by the users. The users may only access the subject information when the owner is utilizing or control-sharing the same. For the purpose of the present invention, the term “control-share” shall mean an owner/user shares a subject information with others while he himself is also utilizing the same.

It is conceivable that the owner can control-share multiple subject information (e.g., multiple music pieces, video pieces, etc.) to different visitor groups simultaneously. The owner can also control a date and a time that the transmission will occurr. Once the transmission has been intitated, the users, who are already connected to the SA 16 via the visitor clients 24-28, receive the transmitted information along with encoded “ownership” information. The encoded ownership information (such as the URL information) indicates who is the owner, and where is the SA that is under the owner's control for sharing the transmitted information. The visitor clients 24-28 must maintain the communication connection to the SA 16 in order to keep receiving the transmission of the information. Once received, the transmitted information may be stored in a temporary and/or permanent storage area (not shown) in the visitor clients 24-28. If stored in the temporary storage area, the transmitted information is deleted if the user disconnects from the SA 16. If stored in the permanent storage area, the transmitted information is controlled by the owner, and may only be accessed (re-transmitted) by the user by maintaining or originating the connection to the SA 16. It is understood that in order to play the subject information, the owner of the SA must be control-sharing the same subject information. For example, if two different musical pieces are available on the SA 16, and the owner is control-sharing only one of them, the visitor clients 24-28 can only perform the control-shared one, but not the other one that is dormant. Unlike a downloadable file available to the general public, this added control feature gives the owner extensive management power since he can determine what should be transmitted to whom. The other feature is that once the information control-sharing or transmission starts, it is not interrupted by a newly added visitor client. If one (or all) of the visitor clients 24-28 connects to the SA 16 at a time during the control-sharing of the subject information, the data streaming of the subject information is started from the time the visitor client is actually connected. In a simple scenario, if a song is control-shared by a small group of visitors, and a late comer enters the SA, he has to listen to the performance of the song from where it currently is. He does not have permission to interrupt others' enjoyment and start from the beginning.

The system 10 also comprises a server 18 that includes an authentication and management area 20 and an information repository 22. The authentication and management area 20 manages ownership of and access to the SA 16 as well as the “look and feel” of the SA 16. The information repository 22 contains a plurality of other subject information stored in digital form. The other subject information (which may be related to music, a movie, a book, audio, video, data, and/or multimedia) can be sampled, rented, and/or purchased by the users in addition to his own private subject information collection. For example, the subject information being provided to the SA 16 by the owner client 12 could be music from a private music collection. Additionally, the information repository 22 could hold other music pieces that could be purchased and played in the SA 16, similar to a “music jukebox”.

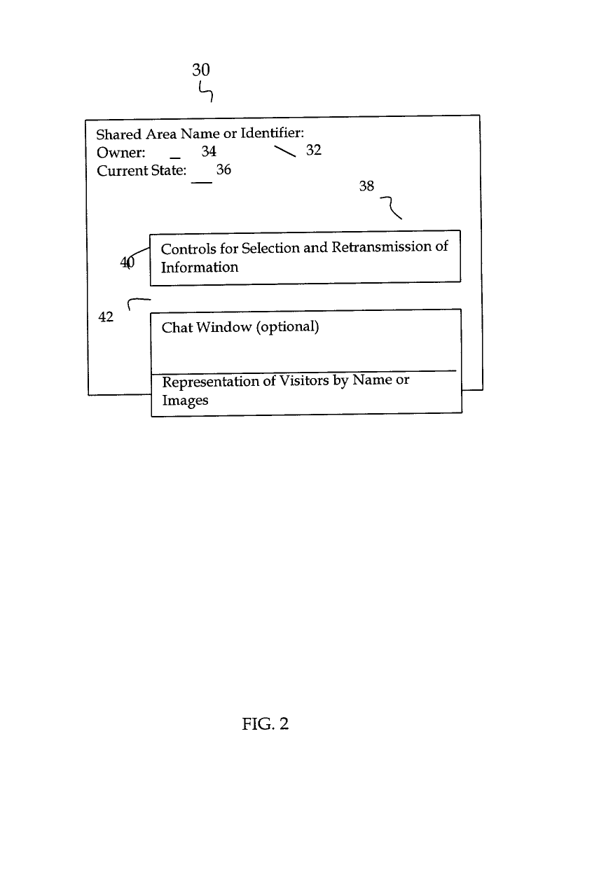

FIG. 2 depicts a simple SA window 30 that includes a SA name (or identifier) 32, an owner name 34, and a current state 36 which includes facts about the subject information being transmitted and the users that have connected. Area 38 permits the users to select and retransmit the subject information while areas 40 and 42 respectively provide chat capabilities and the names of the users. Alternatively, the users can be represented as 2-D graphics and the SA window 30 itself can be shown as a 2-D graphical object.

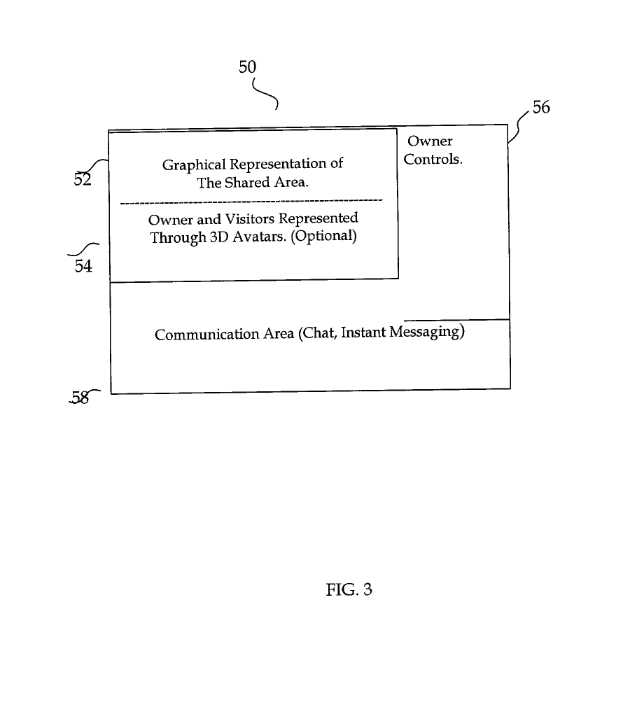

FIG. 3 depicts an elaborated SA window 50 that includes a three-dimensional (or “3-D”) graphical representation 52 of the SA 16, a 3-D human image representation 54 (also known in the graphics as an “avatar”) of the owner and the users, a graphical owner control area 56, and a communication area 58. The owner control area 56 ensures that when a file is stored on a visitor client 24-28, the retransmission of the subject information is controlled by the owner of the SA 16. In one example, the SA 16 is depicted as a 3-D studio or theater while the owner is shown as a host and the invited users are represented as human attendees for the gathering.

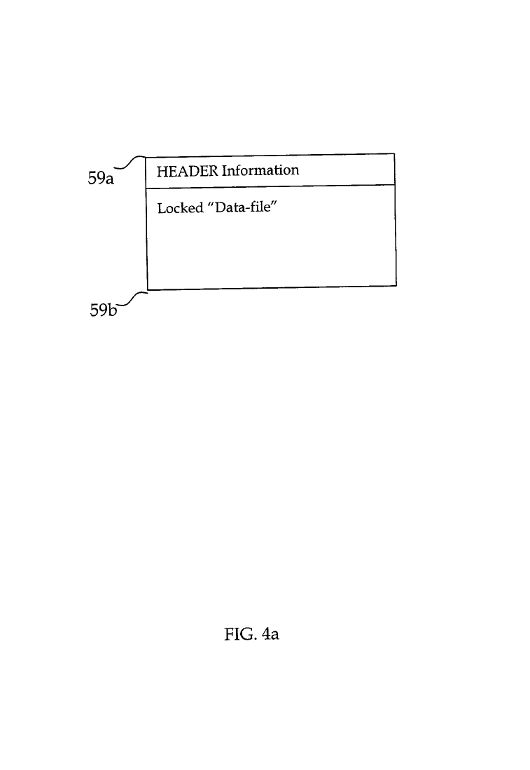

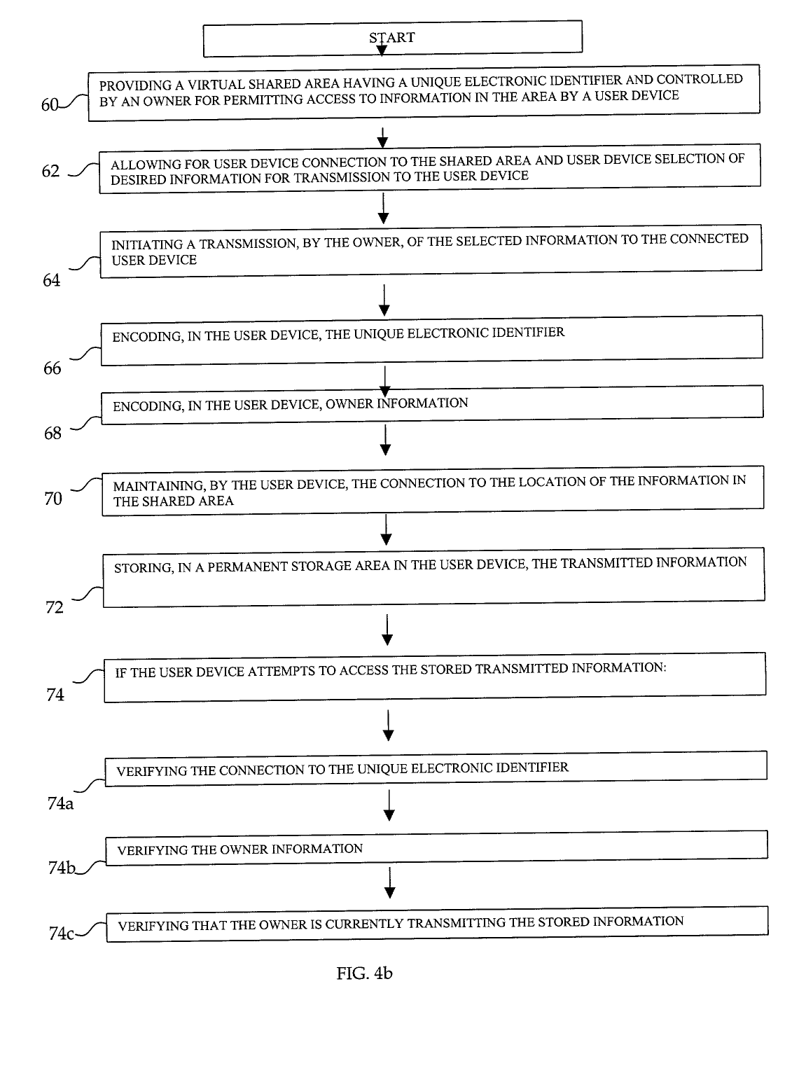

FIG. 4a depicts a visitor client display that includes a header portion 59a and a locked transmitted information (or locked data file) portion 59b. The header portion 59a may include a unique electronic identifier for the SA (SA ID) and owner information which includes the owner's name, contact information, etc. If the subject information is physically downloaded to the visitor client, it will encode SA ID and the owner information of the SA 16. In addition to the SA ID, another unique identifier identifying a specific portion of the SA (Location ID) may also be encoded. For example, the SA 16 may be depicted as a music studio which has a plurality of rooms, each room would need a Location ID to identify its existence in the SA 16. When an attempt is made to use or access a particular piece of subject information which may be stored in a file, the visitor client will have to verify the existence of the owner, the SA ID, and the Location ID in addition to its continuous connection to the SA 16. Once it is determined that the owner is control-sharing the subject information, a positive verification of the state of the SA 16 and the physical connection to that SA are confirmed and the subject information becomes accessible. In one example, the downloaded file becomes unlocked at this point for the user.

For the purposes of checking a connection to the SA, a query will be acceptable. For example, on the Internet, there is no physical connection, but rather connection through TCP/IP queries. To get connected, in such a situation, the user would initiate a query to the SA to get the current state of the SA, which in return will indicate current data file(s) for the subject information under use or being control-shared. The visitor client will start using the same data file and periodically query the SA to continue its use of the data file. If the connection is broken, the use of the data file at the visitor client will be stopped. If the data file is a timed sequence of the subject information, such as a music or video file, then the starting point for the user to playback the data file will be the instant when the visitor client connects or joins the SA. On a non-computing network appliance (such as MP3 hardware), there may not be a visible user interface for identifying the SA, but control user interface such as simple functionality for file selection, volume control, etc. can be implemented.

FIG. 4b depicts a method for sharing information from a virtual shared area in a communication network. The method begins at step 60 where a virtual SA identifiable by its SA ID is provided. The SA is controlled by an owner for screening access to subject information in the SA by a user through a visitor device. At step 62, a connection is established between the SA and the visitor device. The user is allowed to access the desired subject information for transmission to the visitor device. At step 64, the owner of the SA initiates a transmission of the selected subject information to the connected visitor device. At steps 66 and 68 respectively, the SA ID and/or Location ID along with owner information are encoded in the visitor device. The method proceeds to step 70 where the visitor device maintains the connection to the SA. At step 72, the transmitted subject information is stored in a permanent storage area in the visitor device. If the visitor device attempts to access the stored subject information at step 74, the method proceeds to steps 74a, 74b, and 74c respectively where verifications are completed to confirm the connection to SA, the owner information, and the fact that the owner is currently control-sharing the stored subject information.

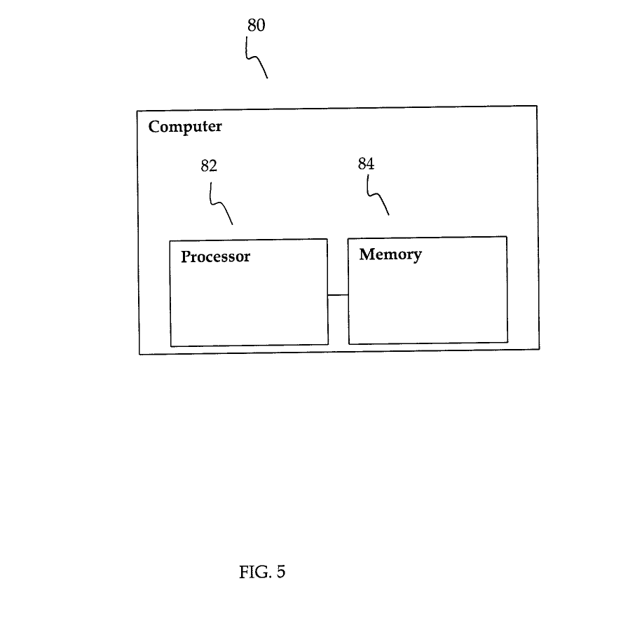

FIG. 5 depicts a computer 80 that comprises a processor 82 and memory 84. The computer 80, may be a personal computer or laptop, containing computer programs. Such computer can be used for the owner client 12, the SA 16, the server 18, the visitor clients 24-28 and/or any device that needs to transmit, receive, and share information. The processor 82 may be a central processing unit, digital signal processor, microprocessor, microcontroller, microcomputer, and/or any device that manipulates digital information based on programming instructions. The memory 84 may be read-only memory, random access memory, flash memory and/or any device that stores digital information. The memory 84 is coupled to the processor 82 and stores programming instructions (i.e. a computer program) that, when read by the processor 82, causes the processor to perform the steps discussed above with reference to FIG. 4.

It is further understood that other modifications, changes and substitutions are intended in the foregoing disclosure and in some instances some features of the disclosure will be employed without corresponding use of other features. Additionally, singular discussion of items, devices, and/or computers located in the system 10 is also meant to apply to situations where multiple items, devices and/or computers exist. Further, the system 10 may include additional and/or fewer items, devices and/or computers that perform similar functions discussed in the disclosure. Also, the owner or the hosting party has the ability to create a plurality of SAs and provide different and/or similar subject information to each of the areas. Additionally, the plurality of other subject information stored in the information repository 22 may be the same as the owner's private information collection 14. Further, the simple SA window 30 and the elaborated SA window 50 may be combined and/or may offer additional information and features to the users.

In another example of the present invention, visitors/users can also purchase “permanent” accesses to the information repository 22 so that they can frequent the same virtual SA whenever needed. The owners will get an identification (e.g., a “token”) listing them as the originators or owners of certain subject information in the repository 22. The owners can trade these tokens, which cannot be duplicated, with other users or lend tokens to others.

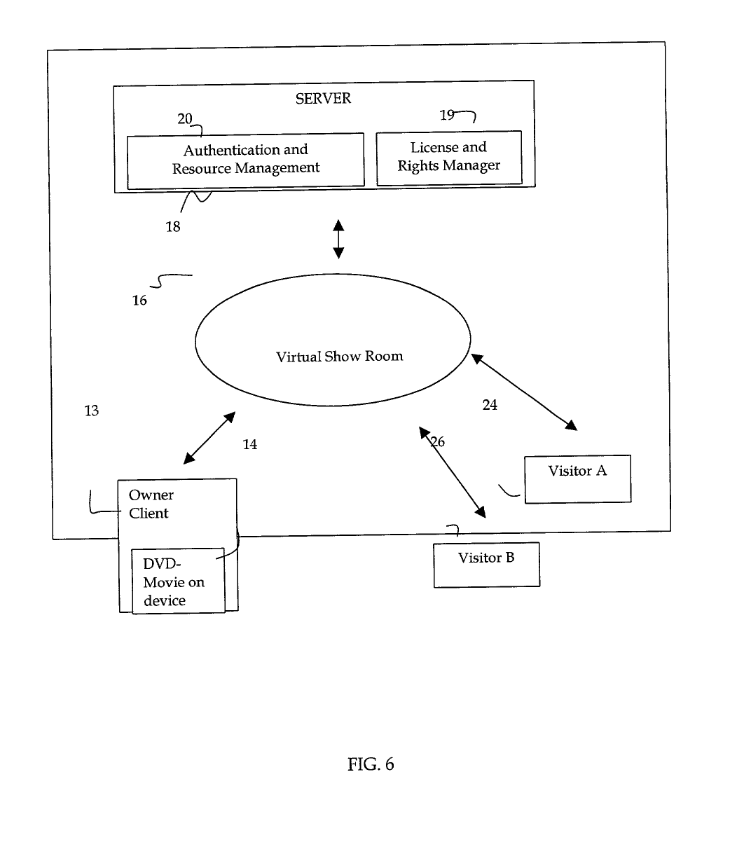

Referring to FIG. 6, a schematic is shown to illustrate how an owner invites a plurality of visitors to join him to view a movie in the SA according to one example of the present invention. In a normal situation today, one can play a movie on his home VCR or DVD player and invite a house full of guests to join him in a private showing of the movie. Every guest must physically be there in the room to view the shown movie. If for any reason that one guest has to leave the room, he is no longer able to continue viewing the movie. One example of the present invention can create such a “show room” in the virtual SA to invite guests selected by the owner to share the movie together without requiring the invited guests to gather together in any physical location. In the current example, the SA 16 is a virtual show room on the communication network, and the owner can play his selected movie from the owner client 12. The movie is first uploaded to the virtual show room, and downloaded in a time-synchronized fashion to visitor clients. As the data for the movie is streaming towards each visitor client, the visitor can view the movie in a real time fashion with the owner as well as other invited visitors. It is noted that the movie is played on every participating visitor client in a time-synchronized fashion so that if one visitor breaks away from the virtual show room, the playing of the movie is not interrupted. On the other hand, if a visitor joins the virtual show room, the movie does not start from the beginning. More precisely, the newly joined visitor has to watch whatever other visitors are watching at the moment. The server 18 is deemed to host the virtual show room with many control mechanisms installed which are accessible only by the owner. One control feature is that it includes a license right manager 19 which monitors the right of the owner to play and the right of the visitor to view the played movie. Another control the owner has is that he can specify when he wants to play the movie for all the visitors. Therefore, the movie can be downloaded and stored in a temporary memory on each visitor client, and the playing of which will be triggered by a control message sent by the owner or automatically timed message at a predetermined time. During the show, the owner still has the control over the movie in the virtual show room, and the license right manger 19 can verify the status of the visitors at predetermined time intervals. In another alternative, the owner does not have to upload the movie. He can obtain the movie from an information repository 22 such as an online movie rental store. The movie is uploaded directly from the online movie rental store to the virtual show room at a time preferred by the owner so that the owner can exercise his control during the show time. Although the immediate example is illustrated in the context of having a private showing of the movie, it is also contemplated by the present invention that any subject information can be shown and shared in the virtual space as it is controlled by a predetermined party.

In another example of the present invention, multiple owners can access the virtual SA and share control in a predetermined manner. Taking an example of sharing music CDs on the SA, if a group of friends have the intention to play music CDs that each owns, the control is not vested in any particular one owner, but rather shared in a predetermined manner among them through the “Authentication & Resource Management” (ARM).

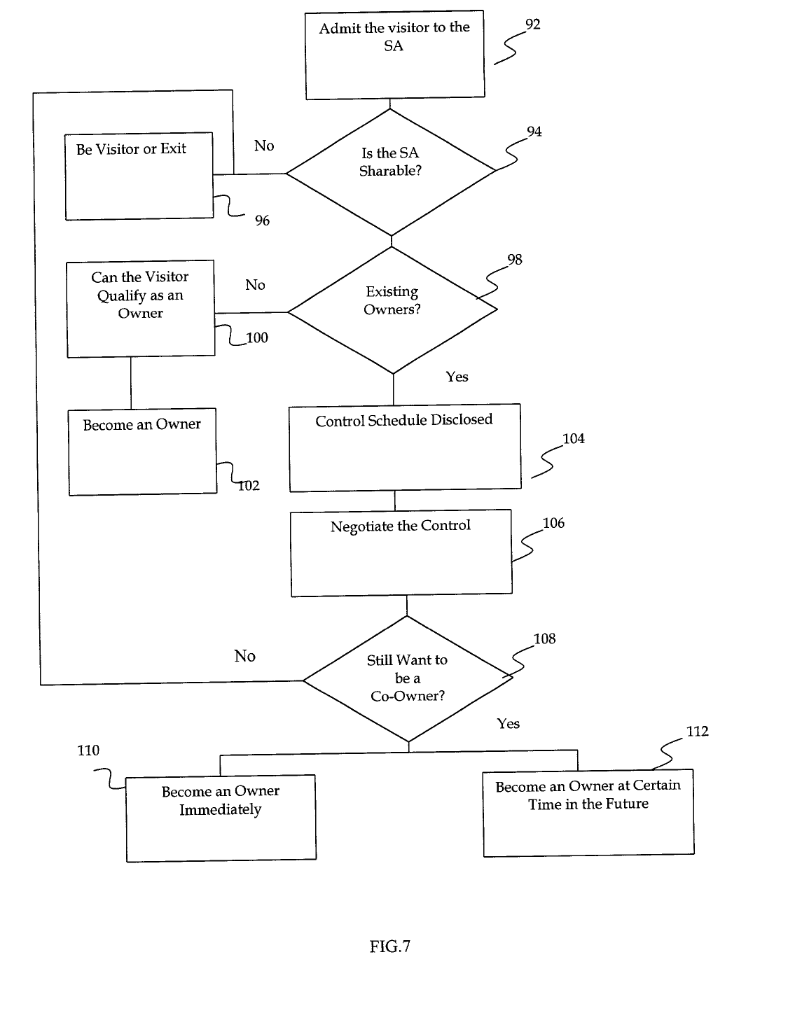

Referring to FIG. 7, it illustrates a flow diagram 90 representing steps taken for sharing the control of the SA according to one example of the present invention. For instance, when a particular visitor accesses the SA, in step 92 he first has to be authenticated by the ARM through authentication mechanisms such as a password protection. Once he is admitted to the SA, and if he has the intention to be a co-owner, he has to check with the SA to see whether this SA is sharable in step 94. If in step 94, the ARM indicates that the SA is not sharable, the visitor will then have an option in step 96 to be a passive visitor as illustrated above with regard to FIGS. 1-5, or he can choose to exit from the SA if his intention is not to be a passive visitor. If the ARM confirms that the SA he is in is sharable, the visitor further checks with the ARM whether there has been any other owners already existing (step 98). If he happens to be the first one, he then has to be qualified to be the owner in step 100. The ARM can have certain admission criteria set up to prohibit certain visitors to be the owner. If he qualifies, he will control the SA as an owner in step 102. In a simpler example, the ARM can also admit anyone to be the owner as long as he is the first one asking. If back in step 98, the ARM informs the visitor that there is at least one existing owner, the ARM would then disclose to the visitor a control schedule in step 104. The control schedule should include all necessary information about the control vested in the current owner. This information may be referred to as control attributes, and may include detailed information about the existing owner (i.e., how long he has been in control, when he is going to cease the control, etc.).

At this point, various control negotiation procedures can be implemented as indicated by step 106. For example, the ARM can follow a strict First-Come-First-Serve rule so that the later arrived visitor has to wait for the existing owner to relinquish his control in order to take over the SA. As an alternative, the ARM may allow a negotiation to take place between the existing owner and the newly arrived visitor. For instance, the ARM may send a message to the existing owner informing him that a new visitor wants to be a co-owner, and asking whether the existing owner is willing to cease control immediately. Or, if the visitor provides a starting time that he wants to take over the SA, the message can ask the existing owner to consider ceasing control at a certain time in the future. The existing owner should also perform according to some pre-existing rules. For example, if it is agreed that each owner should be entitled to a certain minimum period of time (e.g., 15 minutes) for his exclusive control of the SA, he can simply reject the request of the visitor without offending the visitor. If it is agreed beforehand that after having the control over the SA for another predetermined time period (e.g., 1 hour), each owner should relinquish the control to the first visitor who requests to be the co-owner. Then, the existing owner may want to negotiate with the visitor to extend his control for some specific reason such as finishing the performance of a song. The negotiation can be carried out between the two parties and facilitated by the ARM using various communication software tools such as messages, signals, etc. The ultimate goal is to help the existing owner and the visitor to reach an agreed control schedule so that the SA can be shared in an amicable manner. At a certain point of the negotiation, the ARM would confirm with the visitor to determine whether he still intends to be the co-owner (step 108). If he no longer desires so, he can be directed to step 96 to remain as a visitor or exit altogether. If he still wants to be the owner, the ARM would grant the control to him either immediately in step 110 or at certain time in the future as the control schedule permits in step 112. In short, the ARM shall perform consistent with the negotiation result between the visitor and the existing owner to decide who should take over the control of the SA. Once the visitor becomes the co-owner, the control schedule is updated to reflect the intended control schedule of the visitor. When the visitor officially takes over the SA, the control schedule is again updated.

Consistent with the steps as shown in FIG. 7, a group of friends can share music CDs in the SA. For instance, member A can first access the SA, become the first owner, and start to play CDs in his possession. Then, member B can join the SA and intend to play his CDs as well. The ARM can allow them to “rotate” the control of the SA sequentially on a First-Come-First-Serve basis, the ARM can also allow them to decide between themselves who should play the CDs at any moment. The ARM can also put up a control schedule to allow each member to “fill in the blanks” for the time slots available for him to play his CDs. At any moment, there should be only one owner who takes exclusive control of the SA, while all the others are passive visitors. It is possible that during the control of one owner, visitors can still communicate with the owner or among themselves to negotiate who gets to be the next owner with or without the assistance of the ARM. It is also possible that the visitors can communicate with the owner and other visitors through messages, chat rooms, or other similar communication tools to express their views about whatever is performed in the SA. For instance, the visitors can comment on the music CD that is being played at the moment, and ask the owner to stop playing, to fast forward, or to replay the CD. Based on the reaction of the visitors, the owner may want to make appropriate changes, but he does not have to. He can still insist on playing according to his original plan.

The virtual SA will also contain additional features such as a list of clubs or organizations devoted to a particular type of music (such as Jazz, Soul, etc.) or by artists, owners, etc. Other features include a private bulletin board with limited access where owners can post when they intend to play a song that they own. A mechanism for commercial entities to sponsor the control-sharing of particular information may also be provided.

The present invention as illustrated in various examples above thus provides a method and system for sharing information by multiple parties with the control vested in one particular party. The present invention can be implemented to achieve various goals. For example, an independent party, in addition to the owner, can sponsor the playing of particular songs for various participating visitors in the virtual SA. A typical scenario is that an advertising agency may want to pay the owner a fee to post its advertisement during the control-sharing period.

For the purpose of the present invention, the definition of the virtual shared space/area is broadly envisioned. Taking the Internet as an example, the virtual shared space/area can be an entire web site, but it can also be a portion of the web site. Putting this concept in perspective, in a more specific situation, if a virtual studio is depicted on the web site, the virtual studio itself can be considered as the virtual shared area, but each virtual room in the virtual studio can also be referred to independently as a virtual shared area. The virtual shared space can be identified by a unique electronic identifier without regard to the size thereof (as explained in more detail above). Therefore, a communication link to the virtual shared area can be readily identified. For instance, in the situation of a virtual studio, if a user connects to the virtual studio, but has not made any connection to a particular virtual room, he is not allowed to share the control-shared subject information. On the other hand if he is connected to a first virtual room and enjoys the shared information, and then disconnects from this virtual room and switches to a second virtual room, his communication link is deemed as broken from the first virtual room (or the first virtual shared area), but maintained for the second virtual room (or the second virtual shared area). The fact that he is connected to the web site (i.e., a bigger virtual shared area) all the time during the switch does not affect the determination of the activity of the communication link to a particular shared area such as the virtual room.

The present invention enjoys several advantages. For example, owners can control who receives the subject information, when and where it can be obtained and when and where it can be listened to, read, or seen. This is possible because the users may only access the subject information the owner is transmitting/control-sharing and because stored transmitted information in a temporary storage area of a user's device is deleted if the user client disconnects from the SA.

The above disclosure may provide many different embodiments, or examples, for implementing different features of the invention. Specific examples of components, and processes are described to help clarify the invention. These are, of course, merely examples and are not intended to limit the invention from that described in the claims.

While the invention has been particularly shown and described with reference to the preferred embodiment thereof, it will be understood by those skilled in the art that various changes in form and detail may be made therein without departing from the spirit and scope of the invention, as set forth in the following claims.

What is claimed is:

1. A method for sharing a virtual area among a plurality of users, the method comprising:
admitting a first user of the virtual area to take control of the virtual area for sharing a first subject information;
admitting a second user to the virtual area, the second user having a desire to control the virtual area for sharing a second subject information;
negotiating the control of the virtual area between the first and the second users; and
control-sharing either the first or the second subject information in the virtual area according to the negotiation,
wherein the control of the virtual area is exclusively shared by the first and second users, and the first or second subject information is broadcast in the virtual area.

2. The method of claim 1 wherein the step of admitting a first user further comprises authenticating the first user and qualifying the user to control the virtual area.

3. The method of claim 1 wherein the step of admitting a second user further comprises:
informing the second user about a sharability of the virtual area; and
disclosing a control schedule of the virtual area,
wherein the control schedule comprises necessary information regarding the first user and his control attributes.

4. The method of claim 1 wherein the step of negotiating further comprises facilitating communications between the first and second user to reach an agreed control schedule.

5. The method of claim 1 further comprising admitting other users as passive users who have no desire to control the virtual area.

6. A method for sharing a virtual area among a plurality of users for performing at least one multi-media item, the method comprising:
admitting a first user to be an owner of the virtual area to control-share a first multi-media item;
admitting a second user to the virtual area, the second user having a desire to control-share a second multi-media item;
negotiating a control of the virtual area between the first and the second users; and
adjusting the control of the virtual area according to a negotiation result so that either the first or the second user can become the owner of the virtual area and control-share the corresponding first or second multi-media item,
wherein the users admitted to the virtual area who are not the owner can form a passive audience to share the control-shared multi-media item.

7. The method of claim 6 wherein the step of admitting a first user further comprises authenticating the first user and qualifying the first user to control the virtual area.

8. The method of claim 6 wherein the step of admitting a second user further comprises:
informing the second user about a sharability of the virtual area; and
disclosing a control schedule of the virtual area,
wherein the control schedule comprises necessary information regarding the owner and his control attributes.

9. The method of claim 6 wherein each member of the passive audience shares the multi-media item control-shared in the virtual area if the member maintains a communication link with the virtual area.

10. The method of claim 6 wherein the owner of the virtual area manages who can be admitted to the passive audience.

11. A method for sharing information by multiple users in a virtual area in a communications network, the method comprising:
providing a virtual shared area having a unique electronic identifier, the shared area being controlled by an owner for permitting access to subject information in the shared area;
allowing a user to connect to the shared area through a user device and transfer at least a part of the subject information to the user device;
encoding, in the user device, the unique electronic identifier of the virtual area;
maintaining, by the user device, the connection to the shared area for keeping the transfer of the subject information;
storing, in a storage area in the user device, the transferred subject information; and
if the user device attempts to access the stored subject information, then:
verifying the connection to the share area;
verifying the owner information; and
verifying that the owner is currently control-sharing the stored subject information.

12. The method of claim 11 further comprising storing the subject information in a temporary storage area in the user device and deleting the stored information in the temporary storage area upon the user device disconnecting from the shared area.

13. The method of claim 11 comprising substantially synchronizing the user device's access to the stored subject information with the control-sharing of the owner.

14. The method of claim 11 further comprising providing means for interacting among the users in the shared area during the control-sharing of the subject information.

15. The method of claim 11 further comprising displaying, to the user, a current state of the shared area.

16. The method of claim 11 further comprising scheduling, by the owner, a predetermined time the subject information will be control-shared.

17. The method of claim 11 further comprising encoding, in the user device, owner information.

18. A method for sharing multi-media information in a virtual studio on the Internet, the virtual studio having a plurality of virtual rooms, the method comprising:
recognizing an owner of a virtual room in the virtual studio;
inviting a plurality of visitors to the virtual room by the owner; and
control-sharing, by the owner, the multi-media information in the virtual room to be shared by the visitors simultaneously if a communication link is maintained between the visitors and the virtual room.

19. The method of 18 wherein the multi-media information is fully downloaded to display devices of the visitors before the control-sharing, wherein such downloaded information is not accessible by any visitor until a verification is made to confirm that the owner is control-sharing the multi-media information and the communication link is maintained between the virtual room and the visitor.

20. The method of 18 further comprising posting a control-sharing schedule by the owner to all the visitors.

21. The method of claim 18 further comprising negotiating, by at least one visitor, with the owner for control the virtual room.

22. The method of claim 18 wherein the multi-media information is owned by the owner.

23. The method of claim 18 wherein the multi-media information is provided by an on-ine repository not owned by the owner of the virtual room.
